(19) United States
(12) Patent Application Publication
(10) Pub. No.: US 2019/0079445 A1
(43) Pub. Date: Mar. 14, 2019

(54) SHEET PROCESSING APPARATUS, IMAGE FORMING SYSTEM, AND PROGRAM

(71) Applicant: KONICA MINOLTA, INC., Tokyo (JP)

(72) Inventor: Hiroyuki WAKABAYASHI, Tokyo (JP)

(73) Assignee: KONICA MINOLTA, INC., Tokyo (JP)

(21) Appl. No.: 16/046,224

(22) Filed: Jul. 26, 2018

(30) Foreign Application Priority Data
Sep. 11, 2017 (JP) 2017-173616

(51) Int. Cl. G03G 15/00

(52) U.S. Cl. CPC G03G 15/6567

(57) ABSTRACT

A sheet processing apparatus includes: a hardware processor that: obtains an image skew amount representing a degree of skew of an image formed on a sheet with respect to the sheet; determines a rotation amount of the sheet generated by a rotational part using the image skew amount obtained by the hardware processor; and controls to rotate the sheet by the rotational part by a rotation amount determined by the hardware processor; the rotational part that rotates the sheet on a plane that conveys the sheet; and a sheet processor that performs predetermined sheet processing on the sheet rotated by the rotational part.

The entire disclosure of Japanese patent Application No. 2017-173616, filed on Sep. 11, 2017, is incorporated herein by reference in its entirety.

### BACKGROUND

### Technological Field

The present invention relates to a sheet processing apparatus, an image forming system, and a program.

### Description of the Related Art

There is a conventionally known sheet processing apparatus that performs various types of sheet processing, such as binding processing and sheet edge cutting, onto a sheet carrying an image formed by an image forming apparatus.

Image formation by the image forming apparatus is performed to allow an image to be positioned straight along an outline of the sheet. In reality, however, the sheet might be discharged with the image skewed with respect to the outline of the sheet.

In such a case, it is desirable to perform processing in a state desired by the user in consideration of skew of the image with respect to the sheet. In cutting edges of the sheet, in particular, it is preferable to properly detect skew conditions of the sheet with respect to the conveyance direction and to thereafter perform skew correction to correct the image to be straight along the outline of the sheet before performing cutting processing.

As an example of the skew correction, for example, JP 2014-151987 A discloses a technique of correcting skew of a sheet by abutting the sheet before image formation against a registration roller in an image forming apparatus. At this time, control is performed to suppress the skew correction in a case where a leading edge or the trailing edge of the sheet is diagonally cut, thereby preventing the processing from being performed with the image inclined against the intention of the user.

The case, however, where skew correction is to be performed on the basis of an edge of the sheet, as in the invention described in JP 2014-151987 A, includes a case where a leading edge of the sheet is abutted against the registration roller, and a case where a sheet side surface is abutted against another reference member.

In a case where the skew correction before image formation is on a leading edge basis by abutment against the registration roller while the skew correction before the post-processing is on a side edge basis by abutment of the sheet side surface against a back-side reference plate abutment, difference edges are used as the basis of skew correction, generating dependence on original outline accuracy of the sheet, producing a case where the sheet is discharged with the image skewed with respect to the outline of the sheet in the end.

In addition, in a case where the image itself formed on the sheet is skewed with respect to the outline of the sheet, execution of skew correction on a sheet edge basis would not lead to proper execution of subsequent sheet processing (for example, cutting processing).

### SUMMARY

The present invention has been made in view of this problem, and an object thereof is to provide a sheet processing apparatus, an image forming system, and a program capable of properly performing sheet processing in consideration of image skew with respect to an outline of a sheet.

To achieve the abovementioned object, according to an aspect of the present invention, a sheet processing apparatus reflecting one aspect of the present invention comprises: a hardware processor that obtains an image skew amount representing a degree of skew of an image formed on a sheet with respect to the sheet; determines a rotation amount of the sheet generated by a rotational part using the image skew amount obtained by the hardware processor, and controls to rotate the sheet by the rotational part by a rotation amount determined by the hardware processor, the rotational part that rotates the sheet on a plane that conveys the sheet; and a sheet processor that performs predetermined sheet processing on the sheet rotated by the rotational part.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an image forming system according to a first embodiment;

FIG. 2 is a block diagram illustrating a functional configuration of the image forming system according to the first embodiment;

FIGS. 3A to 3D are diagrams illustrating skew correction processing according to an embodiment of the present invention;

FIG. 4 is a flowchart illustrating operation of the image forming system according to the first embodiment;

FIG. 5 is a diagram illustrating a schematic configuration of an image forming system according to a second embodiment;

FIG. 6 is a block diagram illustrating a functional configuration of the image forming system according to the second embodiment;

FIG. 7 is a flowchart illustrating operation of the image forming system according to the second embodiment;

FIG. 8 is a diagram illustrating a schematic configuration of a cutting apparatus according to a third embodiment;

FIG. 9 is a block diagram illustrating a functional configuration of the cutting apparatus according to the third embodiment; and

FIG. 10 is a flowchart illustrating operation of the cutting apparatus according to the third embodiment.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

Hereinafter, a first embodiment of the present invention will be described with reference to the drawings.

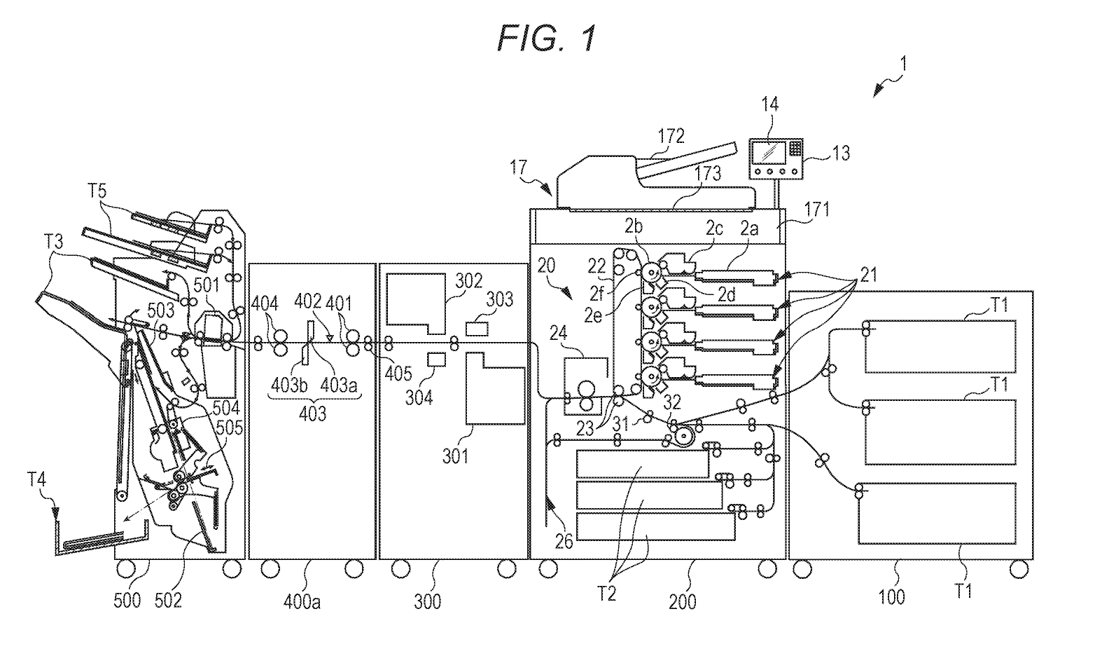

FIG. 1 illustrates a schematic configuration of an image forming system 1 according to the first embodiment.

As illustrated in FIG. 1, the image forming system 1 includes a sheet feeding apparatus 100, an image forming apparatus 200, an image reading apparatus 300, a cutting apparatus 400a (sheet processing apparatus), and a post-processing apparatus 500 (sheet processing apparatus).

The image forming system 1 can cause the image forming apparatus 200 to form an image on a sheet fed from the sheet feeding apparatus 100, thereafter can perform cutting processing on four sides of the sheet by the cutting apparatus 400a, and then can perform various types of post-processing such as forming punch holes and creating a booklet by the post-processing apparatus 500.

[Sheet Feeding Apparatus]

As illustrated in FIG. 1, the sheet feeding apparatus 100 includes a plurality of sheet feed trays T1 and conveys and feeds the sheets stored in each of the sheet feed trays T1 to the image forming apparatus 200.

[Image Forming Apparatus]

As illustrated in FIG. 1, the image forming apparatus 200 includes an image forming unit 20, and an image is formed on a sheet by the image forming unit 20. The sheet to be used can be fed from either the sheet feed tray T1 of the sheet feeding apparatus 100 or a sheet feed tray T2 provided inside the image forming apparatus 200.

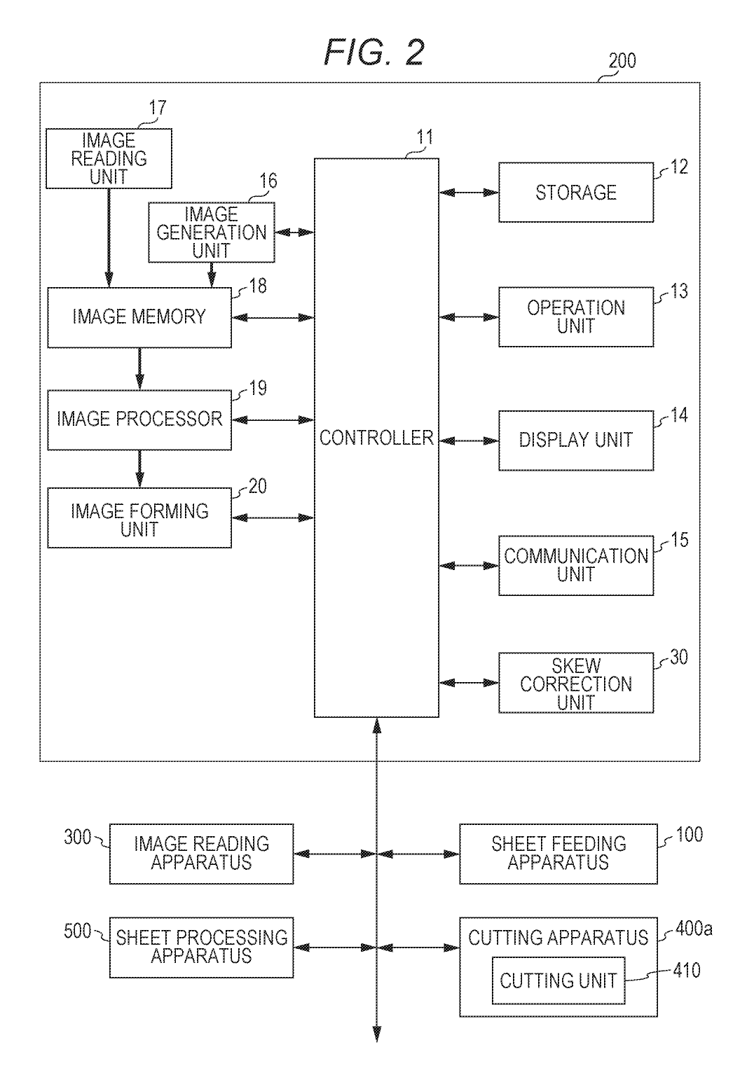

FIG. 2 is a block diagram illustrating a main configuration of the image forming apparatus 200 for individual functions.

As illustrated in FIG. 2, the image forming apparatus 200 includes a controller 11, a storage 12, an operation unit 13, a display unit 14, a communication unit 15, an image generation unit 16, an image reading unit 17, an image memory 18, an image processor 19, an image forming unit 20, and a skew correction unit 30.

The controller 11 includes a central processing unit (CPU), a random access memory (RAM), and controls individual portions by reading and executing various programs from the storage 12.

For example, the controller 11 causes the image processor 19 to perform image processing on image data generated by the image generation unit 16 or the image reading unit 17 and held in the image memory 18, and causes the image forming unit 20 to form an image on a sheet on the basis of the image-processed image data.

Furthermore, the controller 11 controls sheet feeding by the sheet feeding apparatus 100, reading by the image reading apparatus 300, cutting of sheet by the cutting apparatus 400a, post-processing by the post-processing apparatus 500, or the like.

The storage 12 stores a program readable by the controller 11, a file to be used at execution of programs, or the like. As the storage 12, a large capacity memory such as a hard disk is usable.

As illustrated in FIG. 1, the operation unit 13 and the display unit 14 are user interfaces provided on an upper portion of the image forming apparatus 200.

The operation unit 13 generates an operation signal according to user's operation and outputs the generated signal to the controller 11. As the operation unit 13, a keypad, a touch panel integrated with the display unit 14, or the like, are usable.

The display unit 14 displays an operation screen, or the like, in accordance with an instruction from the controller 11. As the display unit 14, a liquid crystal display (LCD), an organic electroluminescence display (OELD), or the like, are usable.

The communication unit 15 communicates with an external apparatus on a network, for example, a user terminal, a server, and another image forming apparatus.

The communication unit 15 receives data (hereinafter referred to as PDL data) in which instruction content for forming an image is described in a page description language (PDL) from a user terminal, or the like, via a network.

The image generation unit 16 performs rasterization processing on the PDL data received by the communication unit 15, and generates image data in a bitmap format.

The image reading unit 17 reads a document surface and generates image data in a bitmap format. An example of the image reading unit 17 applicable is a scanner 171 provided under platen glass 173 as illustrated in FIG. 1. It is also possible to include an automatic document feeder (ADF) 172 to automatically transfer a document to the scanner 171.

In a case where the image data generated by the image generation unit 16 and the image reading unit 17 has pixel values of three colors of red (R), green (G), and blue (B), the controller 11, a dedicated color converter, or the like, performs color conversion into image data having pixel values of four colors of cyan (C), magenta (M), yellow (Y), and black (K), and thereafter holds the converted data in the image memory 18. The pixel value is a data value representing shade of an image, and the data value of 8 bits represents shades of 0 to 255 gradations, for example.

The image memory 18 is a buffer memory that temporarily holds the image data generated by the image generation unit 16 or the image reading unit 17. As the image memory 18, a dynamic RAM (DRAM), or the like, is usable.

The image processor 19 reads image data from the image memory 18 and applies various types of image processing such as density correction processing and halftone processing. The density correction processing is processing of converting each of pixel values of image data so as to set a density characteristic of the image on the sheet to be a target density characteristic. Halftone processing is processing of reproducing halftones in pseudo halftone expression, such as dither processing and error diffusion processing.

The image forming unit 20 forms an image formed with four colors on a sheet in accordance with pixel values of the four colors C, M, Y, and K of each of the pixels of the image data image-processed by the image processor 19.

As illustrated in FIG. 1, the image forming unit 20 includes four writing units 21, an intermediate transfer belt 22, a secondary transfer roller 23, a fixing apparatus 24, and a plurality of sheet feed trays T2.

The four writing units 21 are arranged in series (tandem) along a belt surface of the intermediate transfer belt 22 and form images of individual colors of C, M, Y, and K. As illustrated in FIG. 1, the individual writing units 21 have a same configuration although they form images in different colors and each of the units includes an exposure unit 2a, a photoreceptor 2b, a developing unit 2c, a charging unit 2d, a cleaning unit 2e, and a primary transfer roller 2f.

Each of the writing units 21 forms an electrostatic latent image by first charging the photoreceptor 2b by the charging unit 2d, and thereafter scanning on the rotating photoreceptor 2b with a laser beam modulated on the exposure unit 2a on the basis of the image data. The developing unit 2c supplies toner onto the photoreceptor 2b to develop the electrostatic latent image on the photoreceptor 2b. When the images formed on the photoreceptors 2b of the four writing units 21 are sequentially transferred (primary transfer) onto the intermediate transfer belt 22 individually by the primary transfer rollers 2f in this manner, images with individual colors are formed on the intermediate transfer belt 22. After the primary transfer, the toner remaining on the photoreceptor 2b is removed by the cleaning unit 2e.

When the sheets are fed from the sheet feed tray T1 or T2, the image is transferred (secondary transfer) from the intermediate transfer belt 22 onto the sheet by the secondary transfer roller 23, and thereafter, the sheet is heated and pressurized to perform fixing processing by the fixing apparatus 24. In a case where images are to be formed on both sides of the sheet, the sheet may conveyed to the conveyance path and turned over, and then, conveyed again to the secondary transfer roller 23.

The skew correction unit 30 includes a registration roller 31 and a loop roller 32. A leading edge of the sheet to be conveyed approaches the registration roller 31 and is abutted against the registration roller 31 in a rotation stopped state. After a predetermined time elapses, a loop is formed between the position and trailing edge side of the sheet nipped by the loop roller 32 arranged on the upstream side of the registration roller 31. With action of this loop formation, skew of the leading edge of the sheet is corrected. Next, the registration roller 31 starts rotating at a predetermined timing so as to convey the sheet to the image forming unit 20.

[Image Reading Apparatus]

As illustrated in FIG. 1, the image reading apparatus 300 includes two image reading units 301 and 302 on a sheet conveyance path, and reads both sides of the sheet by the image reading units 301 and 302. Background members 303 and 304 of sheet are respectively disposed at positions facing the image reading units 301 and 302 via a sheet.

The image reading units 301 and 302 capture the background members 303 and 304 together with an image formed on the sheet and a front surface of the sheet, and output two-dimensional imaging data. Each of the image reading units 301 and 302 include: a line sensor (not illustrated) extending in a width direction of the sheet; and a light source also extending in the width direction of the sheet to emit light toward the sheet.

Examples of an applicable imaging element of the line sensor include a complementary metal oxide semiconductor (CMOS) sensor and a charge coupled device (CCD) sensor each having a photodiode as a photoelectric conversion element. The line sensor is disposed in a state where a light receiving portion of the imaging element is exposed on a surface facing the background members 303 and 304 of the image reading units 301 and 302.

[Cutting Apparatus]

The cutting apparatus 400a includes a cutting unit 410 and functions as a sheet processing apparatus. As illustrated in FIG. 1, the cutting unit 410 includes a skew correction roller pair 401 that nips the sheet on the sheet conveyance path, a skew detection sensor 402, a CD cutter 403, and a vertical slitter 404. The cutting apparatus 400a cuts leading and trailing edges and side edges of the sheet conveyed from the image reading apparatus 300.

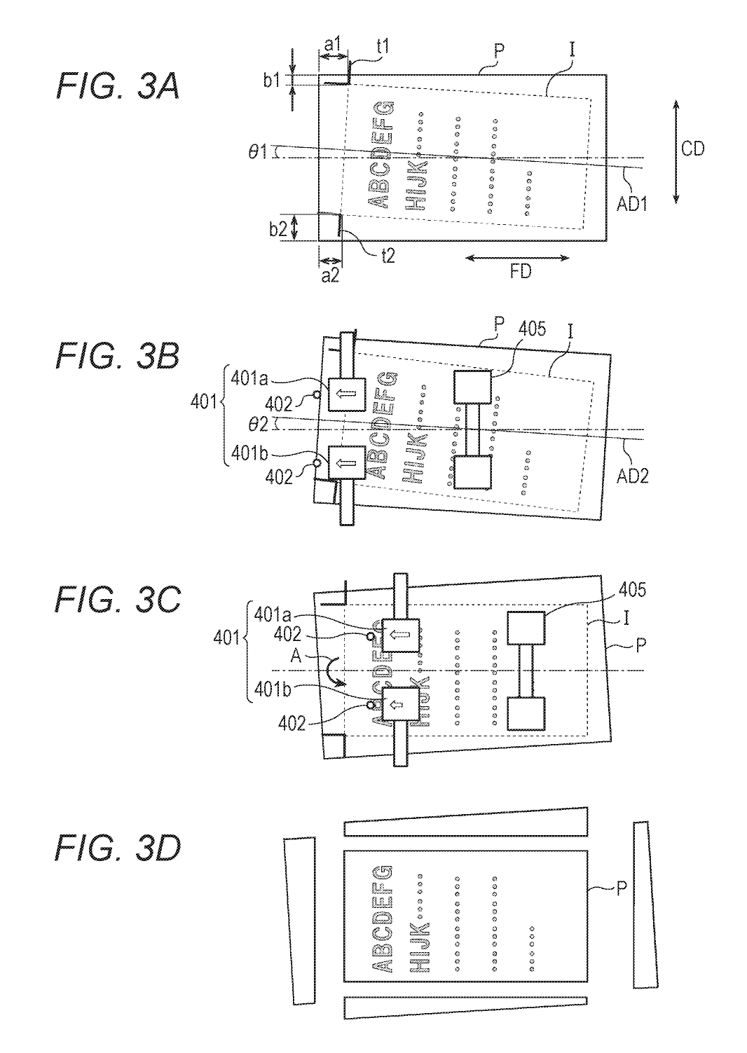

The skew correction roller pair 401 is formed with two rollers provided in the width direction orthogonal to the sheet conveyance direction, and nips and conveys the sheet. Each of the skew correction roller pair 401 can be rotationally driven independently (refer to FIGS. 3A to 3D), with each being rotational at a different speed under the control of the controller 11. That is, as will be described below, it is possible to change the inclination of the sheet with respect to the conveyance direction by a difference in rotational speed between the rollers.

The skew detection sensor 402 includes two optical sensors provided at a predetermined interval in a width direction CD of the sheet and detects a passage timing of the leading edge in the sheet conveyance direction to detect skew of the sheet by the time difference in the detection timing.

The CD cutter 403 extends in the sheet width direction and cuts the leading and trailing edges in the sheet conveyance direction. The CD cutter 403 includes cutting blades 403a and 403b arranged to face each other. Each of the cutting blades 403a and 403b is a plate-shaped member having its longitudinal direction along the sheet width direction. The cutting blades 403a and 403b are swung in a direction approaching each other by a drive unit (not illustrated) to cut off to the edge of the sheet sandwiched between them. The CD cutter 403 can cut the leading edge and trailing edge of the sheet as the sheet moves in the conveyance direction.

The vertical slitter 404 is a slitter having a pair of round blades in a vertical direction. The vertical slitter 404 is disposed to be able to cut both edges in the width direction of the sheet, with its upper and lower blades rotated together with the conveyance of a sheet so as to cut edges in the width direction of the sheet sandwiched between them.

In addition, the cutting apparatus 400a has a plurality of conveyance roller pair for nipping and conveying the sheet. These rollers are provided to be able to be in press-contact or separated from each other under the control of the controller 11.

[Post-Processing Apparatus]

The post-processing apparatus 500 functions as a sheet processing apparatus and includes a punching unit 501, a stacker 502, an aligner 503, a binding unit 504, and a folding unit 505 as illustrated in FIG. 1, and applies various types of post-processing on a sheet conveyed from the image reading apparatus 300, and discharges the processed sheet to a sheet discharge tray T3 or T4. Note that it is possible to manually feed a sheet as a post-processing target from a sheet feed tray T5.

The punching unit 501 punches a sheet to form a punch hole.

The stacker 502 stacks a plurality of sheets. When binding or folding a plurality of sheets, the sheets may be sequentially conveyed to the stacker 502 and stacked.

The aligner 503 abuts the aligning members against the edges in the width direction of the plurality of sheets stacked on the stacker 502 to align the positions of the edges in the width direction.

The binding unit 504 binds a plurality of sheets stacked on the stacker 502 by a stapler or the like.

The folding unit 505 folds a plurality of sheets stacked on the stacker 502.

[Sheet Skew Correction Processing]

Hereinafter, sheet skew correction processing in the first embodiment will be described.

In case of cutting the four sides of the sheet on which the image is formed, the cutting processing is executed after correcting the skew of the sheet with respect to the conveyance direction before cutting. In a case, however, where sheet skew correction is performed by abutting the leading edge or the side edge of the sheet against a reference member, there is a possibility that the skew correction before image formation and the skew correction before the cutting processing do not match. For example, the position of the leading edge of the sheet is corrected by the skew correction unit 30 in the image forming apparatus 200 before image formation, still there is a possibility of occurrence of sheet skew again before the sheet is conveyed to the sheet processing apparatus 400a. Therefore, it is desirable to correct the sheet skew again before the cutting processing.

In addition, there is a demand in four-side cutting of the sheet that there is no image skew with respect to the sheet outline. Therefore, in the present embodiment, image skew with respect to the sheet is detected and skew correction processing of the sheet is performed on the basis of a result of the detection, and thereafter the four sides of the sheet are cut, thereby suppressing image skew with respect to the sheet.

FIGS. 3A to 3D are diagrams illustrating sheet skew correction processing.

A sheet P is conveyed from the image forming apparatus 200 to the image reading apparatus 300, and then, images of one side or both sides of the sheet P are read by the image reading units 301 and 302. Note that it is assumed that the image reading units 301 and 302 read the registration marks formed on the sheet.

FIG. 3A illustrates the sheet P viewed from the image reading unit 302. On the leading edge side of the sheet P, registration marks t1 and t2 are formed at both ends of the sheet P in the width direction CD (direction orthogonal to the conveyance direction FD) of the sheet P, and the image reading unit 302 detects the positions of the registration marks t1 and t2 and transmits a result of the detection to the controller 11 as an acquisition part.

The controller 11 functions as an image skew amount calculation part and measures distances a1 and a2 between the registration marks t1 and t2 and the leading edge of the sheet P and distances b1 and b2 between the registration marks t1 and t2 and the side edges of the sheet P, and calculates an image skew amount with respect to the leading edge of the sheet P on the basis of measurements. Herein, the image skew amount refers to an angle indicated by θ1 in FIG. 3A, between an axial direction AD 1 of the image and the conveyance direction FD

Next, the sheet P is conveyed to the cutting apparatus 400a, and the leading edge position is detected by the skew detection sensor 402. The skew detection sensor 402 transmits a result of the detection to the controller 11. The controller 11 functions as a sheet skew amount acquisition part and calculates a sheet skew amount with respect to the conveyance direction FD of the sheet P on the basis of the detection result. Herein, the sheet skew amount refers to an angle indicated by θ2 in FIG. 3B, between an axial direction AD 2 of the image and the conveyance direction FD.

Next, the controller 11 functions as a determination part and determines a sheet rotation amount on the basis of the calculated image skew amount and the sheet skew amount. For example, as illustrated in FIG. 3A, it is assumed that the image skew amount θ1 is +2°, and the sheet skew amount θ2 is +1θ as illustrated in FIG. 3B. In this case, as illustrated in FIG. 3C, these amounts are summed and the sheet P is rotated by −3° (3° in the direction indicated by the arrow A in FIG. 3C) to achieve a match between the axial direction AD of the image and the conveyance direction FD.

Note that the rotation of the sheet P is executed by the skew correction roller pair 401 as a rotational part. At this time, other conveyance rollers (for example, the conveyance rollers 405 arranged downstream of the skew correction roller pair 401 in FIGS. 3A to 3D) stop rotating and are separated from each other so as not to nip the sheet P. The sheet P is rotated by a rotational speed difference between the skew correction roller pair 401a and the skew correction roller pair 401b. Specifically, in order to achieve the rotation of −3° as illustrated in FIG. 3C, the rotational speed of the skew correction roller pair 401a is increased relative to the speed of the skew correction roller pair 401b.

After the sheet P is rotated as described above, the sheet P is centered by swinging the skew correction roller pair 401 in the width direction CD. Then, in order to accurately cut the sheet P by the vertical slitter 404, the other conveyance roller pairs are brought into pressure contact states and rotation is restarted to convey the sheet P to the downstream side. Note that instead of the centering of the sheet P, the blade of the vertical slitter 404 may be moved in the width direction CD.

Next, the sheet P after rotation is cut at its the leading edge and the trailing edge by the CD cutter, and cut vertically with the vertical slitter 404. Subsequently, the sheet P is conveyed to the downstream post-processing apparatus.

With execution of the above-described skew correction processing, a printed material on which the image is formed straight with respect to the outline of the sheet P is provided.

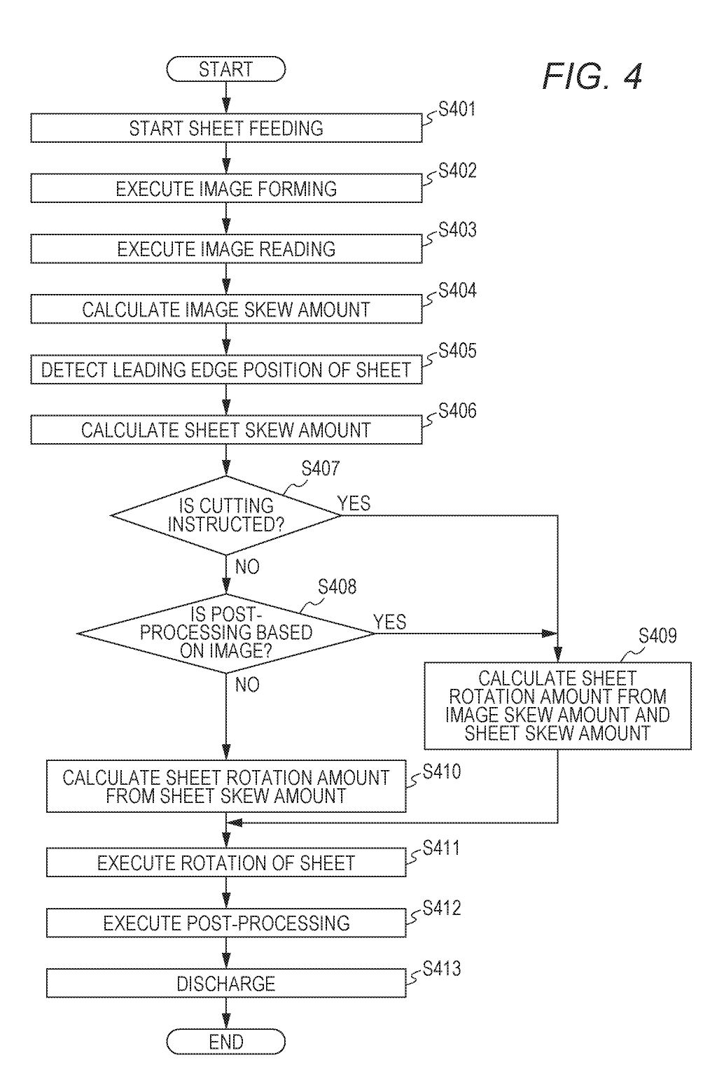

Subsequently, operation of the image forming system 1 according to the first embodiment will be described with reference to the flowchart of FIG. 4.

First, after receiving a print instruction, the controller 11 controls the sheet feeding apparatus 100 to start feeding the sheet P from the sheet feed tray T1 or T2 (step S401).

Next, the controller 11 conveys the sheet P to the image forming apparatus 200 and executes image formation on the sheet P (step S402).

Next, the controller 11 conveys the sheet P to the image reading apparatus 300, controls the image reading units 301 and 302 to read an image position (step S403). Herein, it is assumed that reading of the registration marks formed on the sheet P is executed as reading of the image position. Subsequently, the controller 11 calculates the image skew amount on the basis of the image position read in step S403 (step S404).

Next, the controller 11 conveys the sheet P to the cutting apparatus 400a, controls the skew detection sensor 402 to detect the leading edge position of the sheet P (step S405). Subsequently, the controller 11 calculates the sheet skew amount on the basis of the leading edge position of the sheet P detected in step S405 (step S406).

Next, the controller 11 determines whether execution of cutting on the sheet P is instructed (step S407). In a case where it is determined that cutting execution is not instructed (step S407: No), the controller 11 proceeds to step S408. In a case where it is determined that the cutting execution is instructed (step S407: Yes), the controller 11 proceeds to step S409.

In step S408, the controller 11 determines whether post-processing for the sheet P is performed on an image basis.

Here, post-processing for the sheet P can be performed either on a sheet basis or on an image basis. For example, when an image is skewed with respect to the outline of the sheet P in a case where a plurality of sheets stacked on the stacker 502 is folded by the folding unit 505 as post-processing, execution of folding line forming on an image basis would lead to non-alignment of the edges of the sheet P being shapeless. In such a case, it is preferable to fold the image on a sheet P center line basis rather than image basis. In this manner, which of execution on a sheet basis or on an image basis would be preferable execution differs depending on post-processing. The setting of this may be determined by the post-processing mode or may be selected by the user.

In a case where the controller 11 determines in step S408 that the post-processing is performed on an image basis (step S408: Yes), the processing proceeds to step S409. In a case where it is determined that the post-processing is not performed on an image basis (step S408: No), the processing proceeds to step S410.

In step S409, the controller 11 calculates the rotation amount of the sheet P on the basis of the image skew amount calculated in step S404 and the sheet skew amount calculated in step S406, and proceeds to step S411. That is, this processing enables the axial direction AD1 of the image to match the conveyance direction FD.

In step S410, the controller 11 calculates the rotation amount of the sheet P on the basis of the sheet skew amount calculated in step S406, and proceeds to step S411. That is, in this case, the rotation of the sheet P in step S411 enables the axial direction AD2 of the sheet to match the conveyance direction FD, while the skew with respect to the conveyance direction of the image is not corrected.

In step S411, the controller 11 separates the conveyance roller in the cutting apparatus 400a, controls the rotation of the skew correction roller pair 401 to execute rotation of the sheet P.

Subsequently, the controller 11 conveys the sheet P to the post-processing apparatus 500, executes designated post-processing (step S412), discharges the sheet P to the sheet discharge tray T3 or T4 (step S413) to complete control.

As described above, the image forming system 1 according to the first embodiment includes: the image skew amount acquisition part (controller 11); the rotational part (the skew correction roller pair 401) that rotates the sheet; the determination part (controller 11) that determines the rotation amount of the sheet; the controller 11 that rotates the sheet by the rotational part by the rotation amount determined by the determination part; and the sheet processors (CD cutter 403 and vertical slitter 404) that perform predetermined sheet processing on the sheet rotated by the rotational part. This makes it possible to detect the image skew amount and execute the sheet processing after rotating the sheet, enabling acquisition of an output with the image formed straight on the sheet.

The image forming system 1 according to the first embodiment further includes a sheet skew amount acquisition part (controller 11) that obtains a sheet skew amount, in which the determination part uses the image skew amount and the sheet skew amount to determine the rotation amount of the sheet generated by the rotational part. Accordingly, the sheet processing is executed in consideration of both the skew amount of the leading edge of the sheet and the skew amount of the image with respect to the leading edge of the sheet, making it possible to accurately adjust the rotation amount of the sheet.

The image forming system 1 according to the first embodiment further includes: an acquisition part (controller 11) that obtains image position information from the image reading apparatus; and an image skew amount calculation part (controller 11) that calculates an image skew amount on the basis of comparison between image position information and information indicating an on-sheet position of an image that is set beforehand. Therefore, it is possible to calculate the image skew amount with high accuracy on the basis of the image position detected immediately before being loaded into the cutting apparatus.

In the image forming system 1 according to the first embodiment, the determination part determines the rotation amount of the sheet on the basis of either one or both of the image skew amount and the sheet skew amount in accordance with the type of sheet processing. Therefore, it is possible to select a method optimum for specific processing. For example, it is possible to execute processing on the basis of the sheet skew amount alone in a case where processing on a sheet basis is desirable such as binding processing, while it is possible to execute processing on the basis of the image skew amount alone or on the basis of both the sheet skew amount and the image skew amount in a case where processing on an image basis is desirable such as cutting processing.

In the image forming system 1 according to the first embodiment, the rotational part is a pair of skew correction rollers that can be independently driven in a direction orthogonal to the sheet conveyance direction, in which the sheet is rotated by the difference in rotational speed of each of the pair of skew correction rollers. Therefore, unlike the method of abutting the sheet against a reference plate or the like, skew correction can be achieved without depending on the outline accuracy of the sheet.

While the above embodiment describes a case where the position of the registration mark is detected by the image reading apparatus, it is also possible to perform comparison of the mark positions using a frame line of an image, a ruled line, or a character string, formed on a sheet.

Furthermore, it is allowable to suppress execution of sheet processing in a case where the sheet skew amount is greater than a predetermined amount. In a case where the sheet skew is large, it is highly probable that an image on the sheet is also formed in a largely skewed state. In this case, it is considered to be appropriate to discharge the sheet without sheet processing and to prompt the user for confirmation.

In the above-described embodiment, the sheet is rotated by the difference in the rotational speed of the skew correction roller pair. The present invention, however, is not limited to this, and it is also possible to rotate the sheet by rotating a rotation shaft of the skew correction roller pair.

In this case, the skew correction roller pair may be arranged in the cutting apparatus so as to allow both ends in the width direction to be independently movable in the conveyance direction FD. At this time, while the sheet can be conveyed in the conveyance direction FD by arranging the roller pair so as to set the axial direction of the skew correction roller pair to match the width direction CD of the sheet, it is possible to convey the sheet in a state inclined with respect to the conveyance direction FD by shifting the axial direction with respect to the width direction CD. That is, the sheet can be rotated with the axial direction of the skew correction roller pair changed as described above.

### Second Embodiment

Hereinafter, a second embodiment of the present invention will be described with reference to the drawings.

Unlike the first embodiment, the image forming system 1 in the second embodiment does not include an image reading apparatus. Note that same reference numerals are given to the same configurations as those of the first embodiment, and a detailed description thereof will be omitted.

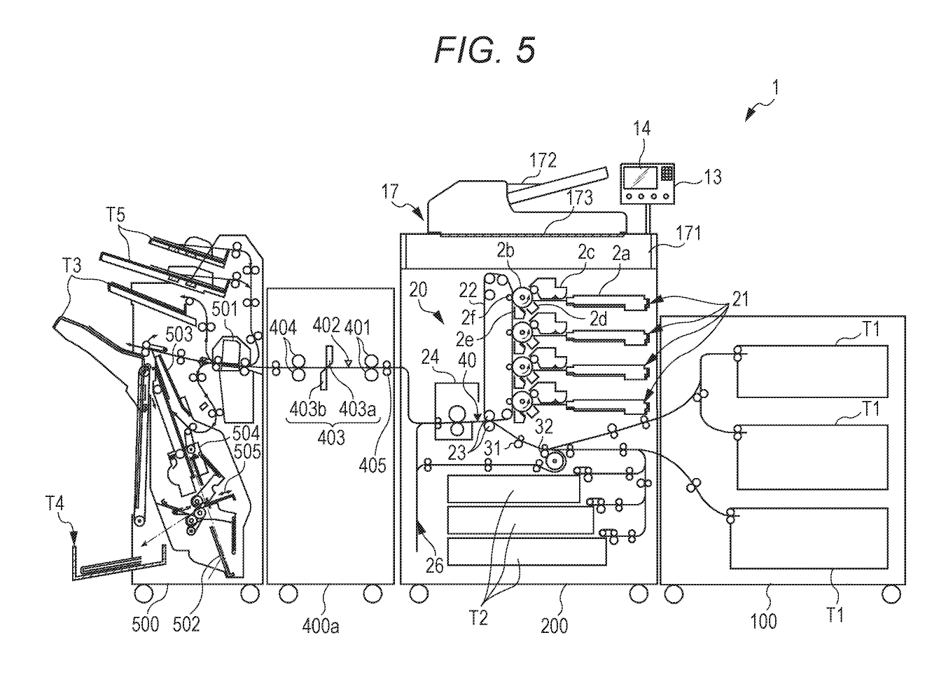

FIG. 5 illustrates a schematic configuration of an image forming system 1 according to the second embodiment.

As illustrated in FIG. 5, the image forming system 1 includes the sheet feeding apparatus 100, the image forming apparatus 200, the cutting apparatus 400a, and the post-processing apparatus 500.

As illustrated in FIG. 5, the image forming apparatus 200 includes a sheet position detection sensor 40. The sheet position detection sensor 40 is disposed downstream of the secondary transfer roller 23 and detects the leading edge position of the sheet P immediately after the sheet P passes through the secondary transfer roller 23. The sheet position detection sensor 40 includes two optical sensors provided at a predetermined interval in a width direction of the sheet and can detect a timing of passage of the leading edge in the sheet conveyance direction to detect skew of the sheet by the time difference in the timing of passage.

Since the relative position between the photoreceptor 2b and the intermediate transfer belt 22 is fixed, an image is formed in a state of being disposed straight with respect to the rotational direction of the intermediate transfer belt 22, and is transferred straight with respect to the sheet conveyance direction at a secondary transfer position. Therefore, in a case where skew of the sheet P in the conveyance direction is detected by the sheet position detection sensor 40, the skew of the sheet can be regarded as image displacement. That is, image position information in the present embodiment indicates the leading edge position of the sheet detected by the sheet position detection sensor 40.

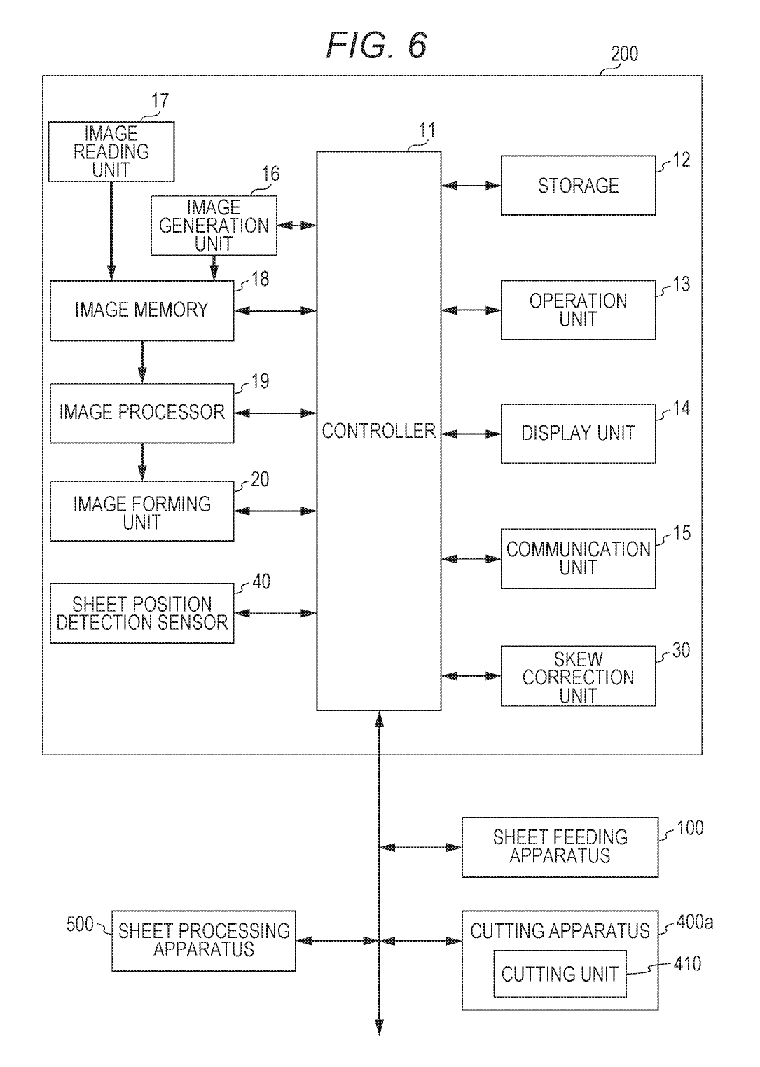

FIG. 6 is a block diagram illustrating a main configuration of the image forming apparatus 200 for individual functions.

As illustrated in FIG. 6, the image forming apparatus 200 includes the controller 11, the storage 12, the operation unit 13, the display unit 14, the communication unit 15, the image generation unit 16, the image reading unit 17, the image memory 18, the image processor 19, the image forming unit 20, the skew correction unit 30, and the sheet position detection sensor 40.

The controller 11 includes a central processing unit (CPU), a random access memory (RAM), and controls individual portions by reading and executing various programs from the storage 12.

For example, the controller 11 causes the image processor 19 to perform image processing on image data generated by the image generation unit 16 or the image reading unit 17 and held in the image memory 18, and causes the image forming unit 20 to form an image on a sheet on the basis of the image-processed image data. Furthermore, the controller 11 controls sheet feeding by the sheet feeding apparatus 100, cutting of the sheet by the cutting apparatus 400a, post-processing by the post-processing apparatus 500, or the like.

[Sheet Skew Correction Processing]

Hereinafter, sheet skew correction processing in the second embodiment will be described.

Unlike the first embodiment, the image forming system 1 according to the second embodiment does not include the image reading apparatus 300, and thus, calculation of the image skew amount based on the image reading result is not performed, and instead, calculation of the image skew amount is performed on the basis of a result of measurement of the sheet position by the sheet position detection sensor 40.

As described above, the image forming apparatus 200 includes the sheet position detection sensor 40, and detects image position information.

The controller 41 obtains image position information detected by the sheet position detection sensor 40 and calculates the image skew amount on the basis of the obtained image position information similarly to the first embodiment.

Processing such as calculation of sheet skew amount and calculation of rotation amount of sheet in the second embodiment are similar to the case of the first embodiment, and thus, detailed description is omitted.

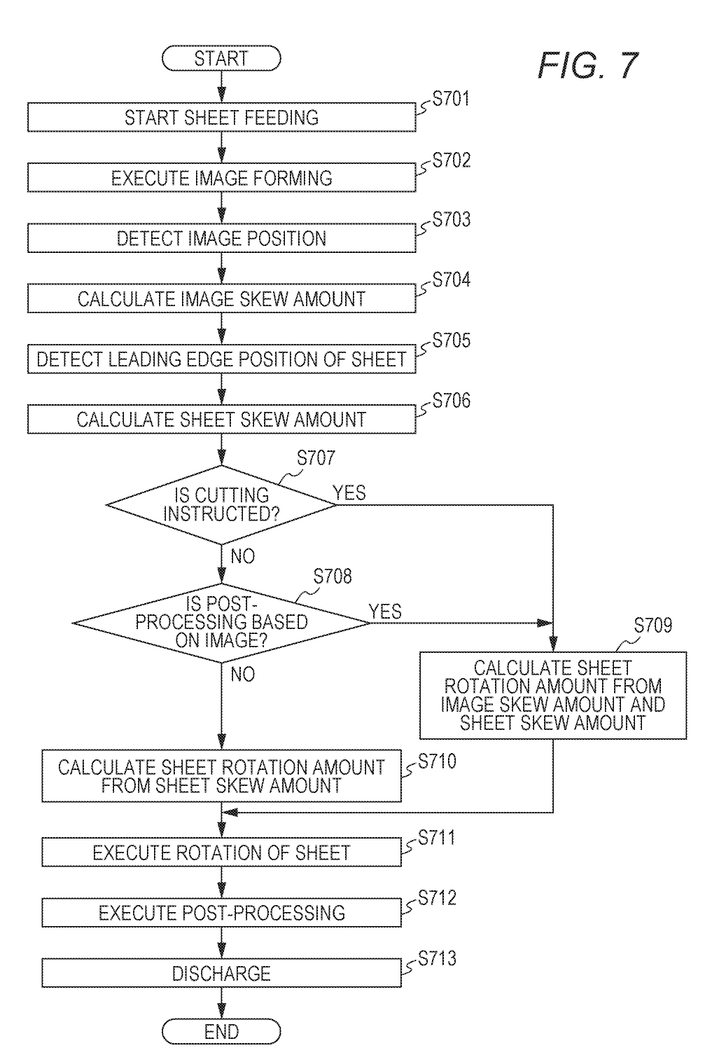

Next, operation of the image forming system 1 according to the second embodiment will be described with reference to the flowchart of FIG. 7.

First, after receiving a print instruction, the controller 11 controls the sheet feeding apparatus 100 to start feeding the sheet P from the sheet feed tray T1 or T2 (step S701).

Next, the controller 11 conveys the sheet P to the image forming apparatus 200 and executes image formation on the sheet P (step S702).

Next, the controller 11 controls the sheet position detection sensor 40 to detect the image position formed on the intermediate transfer belt 22 (step S703). Note that the detection of the image position may be detection of the position of the registration mark formed on the sheet P with respect to the intermediate transfer belt 22, or may be detection of the position of the entire image with respect to the intermediate transfer belt 22. Subsequently, the controller 11 calculates the image skew amount on the basis of the image position detected in step S703 (step S704).

Next, the controller 11 conveys the sheet P to the cutting apparatus 400a, controls the skew detection sensor 402 to detect the leading edge position of the sheet P (step S705). Subsequently, the controller 11 calculates the sheet skew amount on the basis of the leading edge position of the sheet P detected in step S705 (step S706).

Next, the controller 11 determines whether execution of cutting on the sheet P is instructed (step S707). In a case where it is determined that cutting execution is not instructed (step S707: No), the controller 11 proceeds to step S708. In a case where it is determined that the cutting execution is instructed (step S707: Yes), the controller 11 proceeds to step S709.

In step S708, the controller 11 determines whether post-processing for the sheet P is perfbrmed on an image basis. In a case where the controller 11 determines that the post-processing is performed on an image basis (step S708: Yes), the processing proceeds to step S709. In a case where it is determined that the post-processing is not performed on an image basis (step S708: No), the processing proceeds to step S710.

In step S709, the controller 11 calculates the rotation amount of the sheet P on the basis of the image skew amount calculated in step S704 and the sheet skew amount calculated in step S706, and proceeds to step S711.

In step S710, the controller 11 calculates the rotation amount of the sheet P on the basis of the sheet skew amount calculated in step S706, and proceeds to step S711.

In step S711, the controller 11 separates the conveyance roller in the cutting apparatus 400a, controls the rotation of the skew correction roller pair 401 to execute rotation of the sheet P.

Subsequently, the controller 11 conveys the sheet P to the post-processing apparatus 500, executes designated post-processing (step S712), discharges the sheet P to the sheet discharge tray T3 or T4 (step S713) to complete control.

As described above, the image forming system 1 according to the second embodiment includes: the acquisition part (controller 11) that obtains image position information from the image forming apparatus; and an image skew amount calculation part (controller 11) that calculates an image skew amount representing the degree of skew of the image with respect to the sheet on the basis of the image position information. Therefore, the image forming system 1 not having the reading apparatus is also capable of calculating the sheet skew amount on the basis of the reading result in the image forming apparatus.

While the above embodiment uses a configuration in which the sheet position detection sensor 40 is disposed on the downstream side of the photoreceptor 2b on the intermediate transfer belt 22, the arrangement of the sheet position detection sensor 40 is not limited to this. For example, the image formed on the sheet P may be read directly by placing the sensor on a conveyance path downstream of the image forming unit 20, such as downstream of the fixing apparatus 24. In this case, with detection of the position of the image with respect to the sheet P similarly to the first embodiment and executing the control similar to the case of the first embodiment, it is possible to implement the skew correction processing.

### Third Embodiment

Hereinafter, a third embodiment of the present invention will be described with reference to the drawings.

The third embodiment is different from the first embodiment in that the cutting processing of the sheet is executed not by the image forming system but solely by a cutting apparatus 400b. Note that same reference numerals are given to the same configurations as those of the first embodiment, and a detailed description thereof will be omitted.

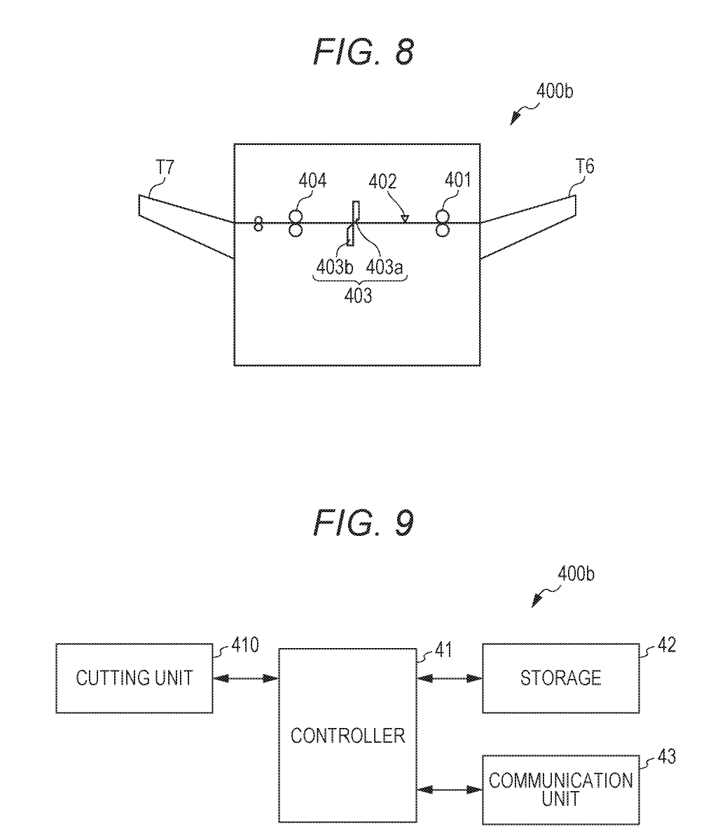

FIG. 8 is a diagram illustrating a schematic configuration of the cutting apparatus 400b. The cutting apparatus 400b cuts the leading and trailing edges and the side edges of the sheet conveyed from a sheet feed tray T6, and discharges the sheet to a sheet discharge tray T7.

FIG. 9 is a block diagram illustrating a main configuration of the cutting apparatus 400b for individual functions.

As illustrated in FIG. 9, the cutting apparatus 400b includes the controller 41, a storage 42, a communication unit 43, and a cutting unit 410.

The controller 41 includes a central processing unit (CPU), a random access memory (RAM), and controls individual portions of the cutting apparatus 400b such as the cutting unit 410 by reading and executing various programs from the storage 42.

The storage 42 stores a program readable by the controller 41, a file to be used at execution of programs, or the like. As the storage 42, a large capacity memory such as a hard disk is usable.

The communication unit 15 communicates with an external apparatus on a network, for example, a user terminal, a server, and another image forming apparatus.

The communication unit 15 receives data (hereinafter referred to as PDL data) in which instruction content for forming an image is described in a page description language (PDL) from a user terminal, or the like, via a network.

The cutting unit 410 includes the skew correction roller pairs 401, the skew detection sensor 402, the CD cutter 403, and the vertical slitter 404, on the sheet conveyance path. The cutting apparatus 400b cuts the leading and trailing edges and side edges of the sheet conveyed from the sheet feed tray T6.

In addition to the above-described configuration, the cutting apparatus 400b may have a configuration including an operation unit and a display unit, allowing user's operation input.

[Sheet Skew Correction Processing]

Hereinafter, sheet skew correction processing in a third embodiment will be described.

Unlike the first embodiment, the third embodiment does not include the image reading apparatus, and thus, calculation of the image skew amount based on an image reading result is not performed and instead, calculation of the image skew amount is performed on the result of previously input image position information. The image position information is information indicating an on-sheet position of an image formed on the sheet, and is represented by image data read by a scanner, for example. The image position information is input to the cutting apparatus 400b beforehand via the communication unit 43 as the acquisition part. Alternatively, in a case where the cutting apparatus 400b includes an operation unit or the like, the image position information such as a distance between the registration mark and the sheet edge may be manually input by the user via the operation unit as the acquisition part.

The controller 41 calculates the image skew amount on the basis of the input image position information similarly to the first embodiment.

Processing such as calculation of sheet skew amount and calculation of rotation amount of sheet in the third embodiment are similar to the case of the first embodiment, and thus, detailed description is omitted.

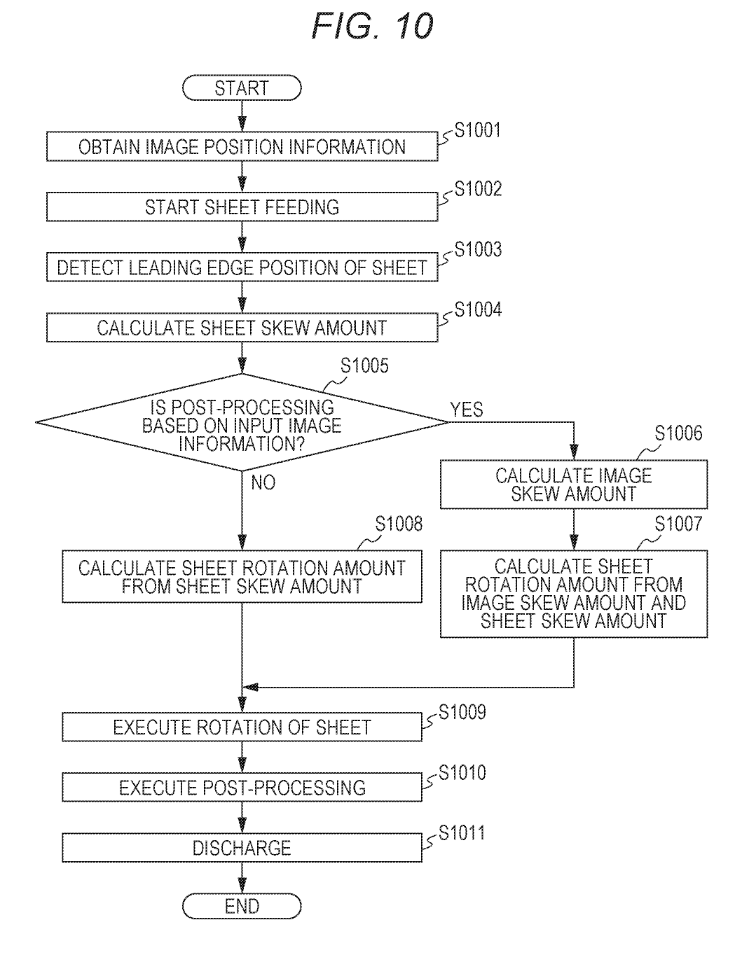

Next, operation of the cutting apparatus 400b according to the third embodiment will be described with reference to the flowchart of FIG. 10.

First, after receiving an instruction to cut a sheet, the controller 11 obtains image position information via the communication unit 43 as an acquisition part (step S1001). Subsequently, the controller 11 starts feeding the sheet P from the sheet feed tray T6 (step S1002).

Next, the controller 11 controls the skew detection sensor 402 to detect the leading edge position of the sheet P (step S1003). Subsequently, the controller 11 calculates the sheet skew amount on the basis of the leading edge position of the sheet P detected in step S1003 (step S1004).

In step S1005, the controller 11 determines whether post-processing for the sheet P is on an input image basis. Similarly to the first embodiment, the determination in step S1005 corresponds to determination whether post-processing is to be performed on the basis of the image formed on the sheet P or post-processing is performed on the basis of the outline of the sheet P.

In a case where the controller 11 determines in step S1005 that the post-processing is performed on an input image basis (step S1005: Yes), the processing proceeds to step S1006. In a case where it is determined that the post-processing is not performed on an image basis (step S1005: No), the processing proceeds to step S1008.

In step S1006, the controller 11 calculates the image skew amount on the basis of the image position information. Next, in step S1007, the controller 11 calculates the rotation amount of the sheet P on the basis of the sheet skew amount calculated in step S1004 and the image skew amount calculated in step S1006, and the processing proceeds to step S1009. That is, this processing achieves a match between the axial direction of the image and the conveyance direction.

In step S1008, the controller 11 calculates the rotation amount of the sheet P on the basis of the sheet skew amount calculated in step S1004, and proceeds to step S1009. That is, the processing achieves a match between the axial direction of the sheet and the conveyance direction, while the skew with respect to the conveyance direction of the image is not corrected.

In step S1009, the controller 11 controls to separate the conveyance rollers in the cutting apparatus 400b, controls the rotation of the skew correction roller pair 401 to execute rotation of the sheet P.

Subsequently, the controller 11 conveys the sheet P to the post-processing apparatus 500, executes designated post-processing (step S1010), discharges the sheet P to the sheet discharge tray T7 (step S1011) to complete control.

As described above, the cutting apparatus 400b according to the third embodiment includes the acquisition part (controller) that obtains image position information from an input unit (communication unit) for the user to input the image position information; and the image skew amount calculation part (controller) that calculates the image skew amount on the basis of the image position information. Therefore, even when the cutting apparatus 400b does not have the image reading function, the image skew amount can be calculated on the basis of user's input.

### Other Embodiments

Hereinabove, the embodiments of the present invention have been described specifically. The above-described embodiments, however, are preferable example of the present invention and the configuration is not limited to this.

For example, while the above embodiment is an exemplary case of a color image forming apparatus in which an image formed on a photoreceptor drum is primarily transferred to an intermediate transfer roller and an image is transferred from the intermediate transfer roller to a sheet by a secondary transfer roller, the present invention is also applicable to a monochrome image forming apparatus in which an image is directly transferred from a photoreceptor drum to a sheet by a transfer roller.

Moreover, while the above embodiment describes an electrophotographic image forming apparatus as an example, the present invention is not limited thereto. For example, the present invention is also applicable to an inkjet image forming apparatus that ejects ink from a nozzle to a recording medium to fix the ink in a desired pattern to record an image onto the recording medium (for example, applicable to an inkjet recording apparatus that ejects ink that cures by a predetermined energy ray from the nozzle and that emits the predetermined energy ray toward the ejected ink on the recording medium to cure and fix the ink on the recording medium).

While the above description discloses an example using a nonvolatile memory, a hard disk, or the like as a computer readable medium used to store the program according to the present invention, the present invention is not limited to this example. As other computer readable medium, a portable recording medium such as a CD-ROM can be applied. Moreover, carrier waves (carriers) are also applied as a medium for providing program data according to the present invention via a communication line.

In addition, detailed configurations and detailed operation of each of the apparatuses constituting the image forming apparatus can be appropriately modified without departing from the spirit and scope of the present invention.

According to an embodiment of the present invention, it is possible to provide a sheet processing apparatus, an image forming system, and a program capable of properly performing sheet processing in consideration of skew of an image with respect to an outline of a sheet.

Although embodiments of the present invention have been described and illustrated in detail, the disclosed embodiments are made for purposes of illustration and example only and not limitation. The scope of the present invention should be interpreted by terms of the appended claims.

What is claimed is:

1. A sheet processing apparatus comprising:
a hardware processor that:
obtains an image skew amount representing a degree of skew of an image formed on a sheet with respect to the sheet;
determines a rotation amount of the sheet generated by a rotational part using the image skew amount obtained by the hardware processor; and
controls to rotate the sheet by the rotational part by a rotation amount determined by the hardware processor;
the rotational part that rotates the sheet on a plane that conveys the sheet; and
a sheet processor that performs predetermined sheet processing on the sheet rotated by the rotational part.

2. The sheet processing apparatus according to claim 1, further comprising a hardware processor that obtains a sheet skew amount representing a degree of sheet skew with respect to a sheet conveyance direction,
wherein the hardware processor
determines the rotation amount of the sheet generated by the rotational part using the image skew amount obtained by the hardware processor and the sheet skew amount obtained by the hardware processor.

3. The sheet processing apparatus according to claim 1,
wherein the hardware processor
obtains image position information indicating an on-sheet position of an image formed on a sheet input by a user, and
calculates an image skew amount representing a degree of skew of an image with respect to the sheet on the basis of the image position information obtained by the hardware processor.

4. The sheet processing apparatus according to claim 1,
wherein the hardware processor
obtains image position information indicating a position at image formation on a sheet from an image forming apparatus, and
calculates an image skew amount representing a degree of skew of an image with respect to the sheet on the basis of the image position information obtained by the hardware processor.

5. The sheet processing apparatus according to claim 1,
wherein the hardware processor
obtains image position information indicating an on-sheet position of an image formed on a sheet from an image reading apparatus that reads an image from the sheet, and
calculates an image skew amount representing a degree of skew of the image with respect to the sheet on the basis of the image position information obtained by the hardware processor.

6. The sheet processing apparatus according to claim 5,
wherein the hardware processor calculates the image skew amount on the basis of comparison between the image position information read by the image reading apparatus and information indicating the on-sheet position of an image that is set beforehand.

7. The sheet processing apparatus according to claim 6, wherein the hardware processor performs comparison using a frame line of an image, a ruled line, or a character string, formed on a sheet.

8. The sheet processing apparatus according to claim 5, wherein the hardware processor calculates the image skew amount on the basis of a comparison between a registration mark formed on a sheet and an outline of the sheet.

9. The sheet processing apparatus according to claim 2, further comprising a hardware processor that obtains a sheet skew amount representing a degree of sheet skew with respect to a sheet conveyance direction,
wherein the hardware processor determines the rotation amount of the sheet produced by the rotational part on the basis of one or both of the image skew amount and the sheet skew amount in accordance with the type of sheet processing applied by the sheet processor.

10. The sheet processing apparatus according to claim 9,
wherein the sheet processor executes cutting processing of cutting an edge of a sheet, and
the hardware processor determines the rotation amount of the sheet produced by the rotational part on the basis of both the image skew amount and the sheet skew amount in a case where the cutting processing is executed by the sheet processor.

11. The sheet processing apparatus according to claim 2, further comprising a hardware processor that obtains a sheet skew amount representing a degree of sheet skew with respect to a sheet conveyance direction,
wherein the hardware processor suppresses execution of sheet processing by the sheet processor in a case where the sheet skew amount is greater than a predetermined amount.

12. The sheet processing apparatus according to claim 1,
wherein the rotational part includes a skew correction roller pair that nips the sheet, the number of the skew correction roller pairs being two provided in a direction orthogonal to a sheet conveyance direction, each of the rollers being rotationally drivable independent of each other, and
the rotational part rotates the sheet in accordance with a difference in rotational speed between the two skew correction roller pairs.

13. The sheet processing apparatus according to claim 1,
wherein the rotational part includes a skew correction roller pair that nips the sheet, and rotates the sheet by rotating a rotation shaft of the skew correction roller pair on a plane that conveys the sheet.

14. An image forming system comprising:
an image forming apparatus that forms an image on a sheet; and
a sheet processing apparatus arranged downstream of the image forming apparatus to apply predetermined sheet processing on the sheet,
wherein the sheet processing apparatus includes:
a hardware processor that:
obtains an image skew amount representing a degree of skew of an image formed on a sheet with respect to the sheet;
determines a rotation amount of the sheet generated by a rotational part using the image skew amount obtained by the hardware processor; and
controls to rotate the sheet by the rotational part by a rotation amount determined by the hardware processor;
the rotational part that rotates the sheet on a plane that conveys the sheet; and
a sheet processor that performs predetermined sheet processing on the sheet rotated by the rotational part.

15. The image forming system according to claim 14, further comprising an image reading apparatus disposed downstream of the image forming apparatus and upstream of the sheet processing apparatus and that reads an image formed by the image forming apparatus,
wherein, in the sheet processing apparatus,
the hardware processor
obtains image position information indicating an on-sheet position of an image formed on a sheet from the image reading apparatus that reads an image from the sheet, and
calculates an image skew amount representing a degree of skew of an image with respect to the sheet on the basis of the image position information obtained by the hardware processor.

16. A non-transitory recording medium storing a computer readable program that causes a computer of a sheet processing apparatus comprising: a hardware processor that obtains an image skew amount representing a degree of skew of an image formed on a sheet with respect to the sheet; a rotational part that rotates the sheet on a plane that conveys the sheet; and a sheet processor that performs predetermined sheet processing on a sheet rotated by the rotational part to perform:
determining a rotation amount of the sheet generated by the rotational part using the image skew amount obtained by the hardware processor; and
controlling to rotate the sheet by the rotational part by a rotation amount determined by the hardware processor.
